(19) United States
(12) Patent Application Publication
(10) Pub. No.: US 2026/0324537 A1
(43) Pub. Date: Oct. 22, 2026

(54) SEED COATING

(71) Applicant: Arevo AB, UMEÅ (SE)

(72) Inventors: Torgny NÄSHOLM, UMEÅ (SE); Regina GRATZ, UMEÅ (SE)

(21) Appl. No.: 19/410,473

(22) Filed: Dec. 5, 2025

(30) Foreign Application Priority Data
Dec. 6, 2024 (SE) 2451250-1

(51) Int. Cl. A01C 1/06; A01N 25/10; A01N 57/28

(52) U.S. Cl. CPC A01C 1/06; A01N 25/10; A01N 57/28

(57) ABSTRACT

The present invention relates to a method of seed treatment, which method comprises providing seeds; and adding L-arginine phosphate source; L-lysine phosphate source; or L-arginine phosphate source and L-lysine phosphate source and binder to said seeds; which method provides a film on each seed.

### TECHNICAL FIELD

The present invention relates to a method of seed treatment. More specifically, the invention relates to a method of coating seeds with L-arginine phosphate, L-lysine phosphate, or L-arginine phosphate and L-lysine phosphate. The invention also embraces a method of preparing a composition suitable for use in the method of the invention.

### BACKGROUND

In agriculture or horticulture, before plantation, seeds are commonly treated with chemical or biological agents, or by physical methods. The purpose for seed treatment varies, often it is done to provide protection to the seed and improve the establishment of healthy crops.

Pelleted seeds were developed for commercial growers who use machines to sow seeds. Pelleted seeds are simply normal plant seeds that have been coated to give them a round, smooth, uniform shape and size, making it less likely for them to jam a mechanical seeder, and increasing the accuracy of the seeder. However, pelleting shortens the lifespan of the seed, so pelleted seeds shouldn't be relied upon to sprout the next year.

Encrusted seeds are coated with a smaller amount of material than that of pelleted seeds. The buildup of coating material is stopped before the treated seed attains roundness. Encrustment is most often used on crops that benefit from seed singulation but don't require post-emergence thinning.

WO 2021/091463 (Arevo AB) relates to compositions and methods for enhancing the biocontrol, specifically enhancing the environment once a seed has been planted. More specifically, a composition, such as a liquid seed coating composition, comprising at least one macro nutrient and at least one microbe is described, wherein the macro nutrient includes nitrogen in the form of a basic L-amino acid in association with phosphorus. The seed coating described in WO 2021/091463 follows the principles of conventional seed encrustment.

In film coating, a layer of thin film is applied to the seed, typically as less than 10% of the mass of the original seed. Such thinner coatings may help with characteristics like flowability. Film coating may take place close to the customers seed production site, avoiding the impracticality of transporting bulk seeds.

In recent years, plants of great economical value are leguminous plants, which have found global use thanks to properties such as disease resistance and a high protein content. Legumes are useful as human and animal food, as wood, and as soil-improving components of agricultural and agroforestry systems. For the latter purpose, farmers grow leguminous plants in the field in between two harvests because leguminous plants have nitrogen-fixating bacteria in their root nodules which converts atmospheric nitrogen into plant available nitrogen compounds. Hence, it enriches the nitrogen content of soil and growth of plants.

The rhizobium-legume symbiosis is the most well researched biological nitrogen fixation system. It has been proved that rhizobia can increase host-plant nitrogen supply by colonizing its roots and exchanging nitrogen fixed by the bacteria for plant photosynthate within root nodules.

However, there is typically limited success from coating seeds with rhizobia since it is difficult to maintain living and active bacterial cells. In fact, often the efficacy of commercial rhizobia inoculants cannot be guaranteed due to the low rate of live rhizobia. It is known that factors such as temperature, humidity, and toxic substances may affect the survival of rhizobia in the seed-coating agent, but there is a need in this field of improved methods for coating of seeds belonging to the plant family of Leguminosae.

### SUMMARY OF INVENTION

The present invention relates to a method of seed treatment, which method comprises the steps of
a) providing seeds;
b) providing a seed coating composition by combining an L-arginine phosphate source, an L-lysine phosphate source, or an L-arginine phosphate source and an L-lysine phosphate source with binder; and
c) coating the seeds of step (a) with the coating composition of step (b) such that a film having a thickness of about 125 μm or less is provided on each seed.

The invention also relates to a seed treated by a method according to the method above.

Further, the invention relates to a composition for use in a method according to the invention, which comprises an L-arginine phosphate source, an L-lysine phosphate source, or an L-arginine phosphate source and an L-lysine phosphate source in combination with a binder.

Finally, the invention also relates to a method of preparing a seed coating composition.

### BRIEF DESCRIPTION OF DRAWINGS

FIG. 1 illustrates the number of soybean root nodules formed per plant (Y axis) as a function of increase of seed nitrogen from film coating of seeds with L-arginine phosphate in accordance with the invention in amounts of 0%, 1.6%, and 4% (X axis) representing the percentage increase in seed nitrogen resulting from the seed coating. Bars represent average numbers±standard error.

FIG. 2 illustrates the height of soybean plants in cm (Y axis) at 82 days after sowing as a result of film coating of seeds with L-arginine phosphate (AP) according to the invention, corresponding to 0.03, 0.06 and 0.09% increase in seed N content. For each concentration, the plant height is presented to the left for a reference plant without treatment according to the invention; and the plant height is presented to the right for a plant treated according to the invention.

FIG. 3 illustrates the leaf concentrations of nitrogen (N) 73 days after sowing as affected by seed coating with L-arginine phosphate corresponding to 0.03; 0.06 and 0.09% increase in seed N content.

FIG. 4 illustrates the leaf concentrations of nitrogen (N) and phosphorus (P) 73 DAS as affected by seed coating with L-arginine phosphate corresponding to 0.03; 0.06 and 0.09% increase in seed N content.

FIG. 5 illustrates the yield of soybean as affected by seed coating with L-arginine phosphate corresponding to 0.03; 0.06 and 0.09% increase in seed N content.

FIG. 6 illustrates the yield of soybeans from plots treated according to farmer standard (Reference) or with a 40% reduction of phosphorus addition compared to the reference or with 40% reduction of phosphorus fertilization+seed coating with L-arginine phosphate corresponding to 0.03; 0.06 and 0.09% increase in seed N content. Percentage numbers on top of the bar for 40% reduction of phosphorus fertilizer+seed coating represents the fraction of yield loss that was compensated by the L-arginine phosphate seed coating.

FIG. 7 illustrates growth performance of pea (Pisum sativum) for which seeds were either left untreated (left group of plants) or treated with a film coating adding 0.8% of extra nitrogen to the seed (right group of plants).

FIG. 8 illustrates yield of pods from pea (Pisum sativum) plants for which seeds were either left untreated or treated with a fil coating adding 0.8% of extra nitrogen to the seed.

### DETAILED DESCRIPTION OF INVENTION

In a first aspect, the invention relates to a method of seed treatment, which method comprises the steps of
a) providing seeds;
b) providing a seed coating composition by combining an L-arginine phosphate source, an L-lysine phosphate source, or an L-arginine phosphate source and an L-lysine phosphate source with binder; and
c) coating the seeds of step (a) with the coating composition of step (b) such that a thin film is provided on each seed, such as a film having a thickness of about 125 μm or less.

The term “source” as used herein includes the ions of L-arginine; L-lysine; and phosphate, as well as complexes or salts of L-arginine phosphate, L-lysine phosphate, or L-arginine phosphate and L-lysine phosphate. As the skilled appreciates, when coated on seeds, the said ions will have formed L-arginine phosphate or L-lysine phosphates.

The L-arginine ions and L-lysine ions may be the only nitrogen present in the mixture obtained from step (b). For example, step (b) may involve combining a solution prepared the amino acids with no other component that have nutritional effect on plants. Thus, the invention may be limited to a method where no nitrogen sources originating from organic material such as manure, peat, clay and the like are included in the mixture of step (b), and hence the coating composition.

The coating composition may be liquid or solid.

Thus, the thin film provided according to the invention differs substantially in thickness from the thicker films commonly obtained with other conventional techniques for seed coating, such as pelleting and encrusting.

In fact, as will be discussed in more detail below, the seed coating of the invention may advantageously use an even thinner film than commonly used in this field, where the phrase “Film coating” usually involves application of a layer corresponding to up to 5% of seed weight.

More specifically, the film provided in step (c) may be in a range of a few μm, such as from about 1 μm or about 2 μm, to about 125 μm or about 120 μm.

In an illustrative example, said film is in the range of from about 5 μm to about 120 μm, for example from about 10 μm to about 120 μm or from about 20 μm to about 120 μm.

Alternatively, said film is in the range of from about 1 μm to about 110 μm, for example from about 1 μm to about 100 μm or from about 1 μm to about 80 μm.

The concentration of L-arginine phosphate source, L-lysine phosphate source, or L-arginine phosphate source and L-lysine phosphate source will be known from step (b), and may e.g. be in the range of 30-100 mg of L-arginine phosphate source, L-lysine phosphate source, or L-arginine phosphate source and L-lysine phosphate source/ml liquid.

As the skilled person will appreciate, other variables will impact what is the most suitable thin film thickness for a specific case, such as the nature of the seeds and the land or soil into which the seeds are to be planted.

Suitable amounts of L-arginine phosphate source, L-lysine phosphate source, or L-arginine phosphate source and L-lysine phosphate source in view of a seeds native or natural content thereof will be discussed in more detail below.

The method of the invention may be performed at room or ambient temperature, i.e. without any added heat.

Additional steps or measures which are well known and conventional in seed coating may be added to or included in the method of the invention, such as drying, cleaning, size grading etc.

Equipment for film coating of seeds is available from commercial sources, and many larger commercial actors have developed their own machines for this purpose. A common feature is that the seeds should be in movement during the process of coating, and advantageously for some time, thereafter, depending e.g. on the thickness applied. For example, tumblers providing a rocking motion may be used, in which seeds may be treated with liquid and also dried, as appropriate.

The binder may be any binder commonly used in seed treatment, which is inert towards the basic L-amino acid used and towards plant performance such as improving plant height or plant yield. Well known examples of binders commonly used in seed treatment are e.g. carboxymethyl cellulose (CMC); polyvinyl alcohol (PVOH or PVA); and gum arabicum.

The binder may be combined with L-arginine phosphate, L-lysine phosphate, or L-arginine phosphate and L-lysine phosphate in any way convenient for the apparatus used, such as a slurry or liquid composition which is sprayed onto said seeds.

The L-arginine phosphate, L-lysine phosphate, or L-arginine phosphate and L-lysine phosphate and binder may be added to the seeds according to any well-known or commonly used method. Thus, the seeds may be stirred, rocked, tumbled or kept in the appropriate movement during this step, and advantageously for some time afterwards, e.g. during drying, in order to achieve a film of desired properties on the majority of the seeds.

The L-arginine phosphate source, L-lysine phosphate source, or L-arginine phosphate source and L-lysine phosphate source may be L-arginine monophosphate source, L-lysine monophosphate source or L-arginine monophosphate source and L-lysine monophosphate source. Alternatively, or additionally the polyphosphates of said basic L-amino acid sources may be used.

As the skilled person will appreciate, and as appears from the use of the term “source” herein, in a liquid seed coating composition according to the invention, not all of the L-arginine and/or Lysine will be present as phosphate salts. A liquid composition may be comprised of complexes of L-arginine or L-lysine with phosphate as well as of free L-arginine ions, L-lysine ions, monophosphate ions and polyphosphate ions. However, in the coating applied to seeds, at least when dried, the amino acid sources will primarily be present as monophosphate salt or polyphosphate salt thereof.

The present inventors have found that if phosphates of one or more of the above discussed basic L-amino acids are provided to seeds as a thin film coating, the performance of the seeds may be greatly improved.

As appears from the appended drawings, organic nitrogen supplied as a thin coating of L-arginine phosphate source; L-lysine phosphate source; or L-arginine phosphate source and L-lysine phosphate source may for example increase the number of root nodules formed per plant as well as the height of plants.

Further, yield of plants as well as the the leaf concentrations of nitrogen (N) and phosphorus (P) may increase as a result of the findings of the invention.

Finally, the present inventors have found that organic nitrogen supplied as a thin coating of L-arginine phosphate source; L-lysine phosphate source; or L-arginine phosphate source and L-lysine phosphate source may alleviate a negative effect of the reduced phosphorus fertilization on the yield of the crop, and may for that reason even promote a higher yield than a plant obtaining full phosphorus fertilization.

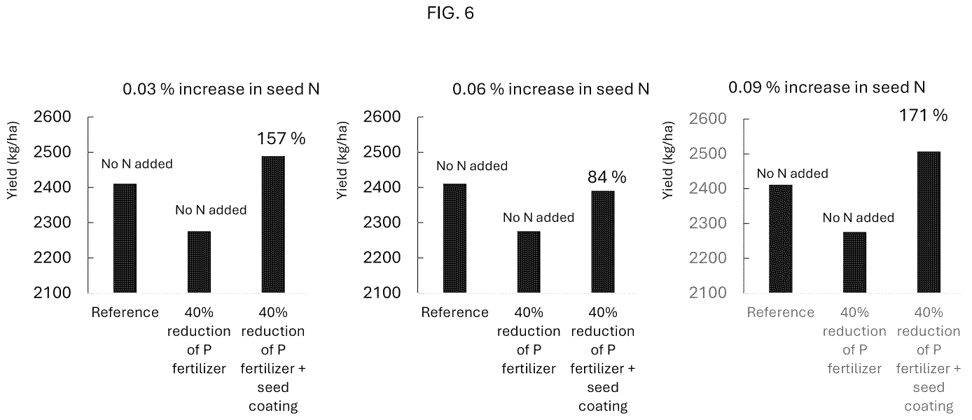

As discussed in relation to FIG. 6 below, the present invention may enable a smaller amount of added fertilizer, such as less nitrogen and/or phosphorous. Also, as discussed in relation to Table 1-4, the present invention may either enable a higher yield of a crop of field corn and of soy compared to the full farmers standard, or the invention may be used to enable a lower rate of fertilizer input for field corn or soy, but with no penalty on yield.

Thus, the present inventors have shown that compared to findings using other seed coating techniques than film coating, a surprisingly small amount of organic nitrogen was sufficient to obtain one or more of the above-discussed advantages of the invention, viewed as a percentage of the N-content of the seed.

More specifically, advantageous results were obtained when L-arginine phosphate source; L-lysine phosphate source; or L-arginine phosphate source and L-lysine phosphate source in an amount that provided a less nitrogen to each seed that the native nitrogen content of said seed.

As discussed above, the present invention is based on the fact that a thin layer of coating comprising L-arginine phosphate source; L-lysine phosphate source; or L-arginine phosphate source and L-lysine phosphate source, such as such as a film having a thickness of about 125 μm or less, allows for supplying a seed with sufficient amounts of organic nitrogen to improve its performance in one or more respects.

A typical nitrogen concentration of a coating composition as discussed herein may be in the range of 1-10% (w/v), as measured in a ready-for-use composition. As the skilled person will appreciate, coating compositions according to the invention may be prepared at higher concentrations of nitrogen to facilitate transportation and/or storage thereof.

Alternatively, considering the above, the amount of organic nitrogen provided by L-arginine phosphate source; L-lysine phosphate source; or L-arginine phosphate source and L-lysine phosphate source to a seed in a thin film may be defined in relation to the native nitrogen and/or phosphorous contents of the seed.

More specifically, the amount of organic nitrogen provided by the L-arginine phosphate source; L-lysine phosphate source; or L-arginine phosphate source and L-lysine phosphate source may be added in an amount that provides a smaller amount of nitrogen to each seed that the native nitrogen content of said seed.

For example, the L-arginine phosphate source; L-lysine phosphate source; or L-arginine phosphate source and L-lysine phosphate source is added in an amount that provides less than about 2% of nitrogen to the seeds, calculated as weight/weight based on the native nitrogen content of the seeds. Specifically, said amount may provide less than about 1.6%, such as within the range of from about 0.01% to 2.0%, such as from about 0.1 to about 1.6% of nitrogen to the seeds, calculated as weight/weight based on the native nitrogen content of the seeds.

As explained in the Experimental part below, the data used to obtain the nitrogen content of native seeds was obtained from [Zambon et al Frontiers in Plant Scienc14; 2023.

In the present method, the treated seeds may belong to the Leguminosae family. Examples of plants seeds belonging to the Leguminosae family are soybeans, peanuts, lentils, alfalfa, and clover.

Suitable levels of nitrogen in the coating of seeds belonging to this family may be in the range of from about 0.01% to about 2.0%, such as from about 0.1 to about 1.6%, of nitrogen to the seeds, calculated as weight/weight based on the native nitrogen content of the seeds.

In a specific example, the seeds are soybeans and the nitrogen may then be in the range from about 1.4 to about 1.8%, such as about 1.6%.

In another example, the seeds are peas comprising about 0.2% of nitrogen.

In the present method, the treated seeds may belong to the Poaceae family. Examples of plants seeds belonging to the Poaceae family are cereal crop seeds and forage crop seeds, such as seeds selected from the group consisting of maize, wheat, rice, oats and barley. In the present context, it is understood that the term “maize” embraces all forms of maize such as corn e.g. field corn.

Suitable levels of nitrogen in the coating of seeds belonging to this family may be in the range of from about 0.6% to about 1.0%, calculated as weight/weight based on the native nitrogen content of the seeds.

In a specific example, the seeds are maize comprising about 0,8% of nitrogen.

As the skilled person will know, certain environmental conditions, such as greenhouse vs. free land culture, may affect the amount of nitrogen required for optimal effect on crop performance.

Further, throughout the present specification and claims, any proportion or amount given for “nitrogen”, “organic nitrogen” or “nitrogen originating from L-arginine or L-lysine”may refer to nitrogen in the form of ionic L-arginine or L-lysine as well as nitrogen in the salt form of L-arginine phosphate or L-lysine phosphate.

The seeds treated may be naked seeds; or seeds pre-treated e.g. with pesticides or any other compound or additive commonly used in this context. Examples of plants seeds belonging to the Leguminosae family are soybeans, peanuts, lentils, alfalfa, and clover.

As mentioned above, the seeds treated may belong e.g. families such as Leguminosae (Fabaceae) or Poaceae. Thus, the seeds may be selected from the group consisting of soybeans, beans, peas, peanuts and alfalfa seeds. Alternatively or additionally, the seeds may be cereal crop seeds or forage crop seeds, such as seeds selected from the group consisting of maize, wheat, rice, oats and barley.

As appears from the above and from the experimental part of the present invention, advantages such as nodule formation improvement have been observed when used with N-fixing plants, i.e. with plants that can convert atmospheric nitrogen into a form that plants can use. This happens either through a symbiotic relationship with bacteria, or in association with, N-fixing microbes.

Thus, the method of the invention may comprise a step of adding one or more microbes capable of the above-discussed direct or indirect N-fixing to the seeds. Said addition may be before, during or after treating the seeds according to the invention. Suitable microbes may belong to genera selected from the group consisting of Rhizobium, Azospirillum, Azotobacter, Herbaspirillum, Enterobacter, Bradyrhizobium, Mesorhizobium and Frankia.

However, in many regions of the world today, soil is already rich in microbes that form efficient symbiosis with legumes, or that form loose associations plants. Thus, even seeds belonging to N-fixing genera, which seeds have been coated with a film in accordance with the invention, may be planted in soil without any intentional addition N-fixing microbes.

A second aspect of the invention is a seed treated by a method according to the invention. Thus, the seed may comprise any of the feature that appear from the invention as described above.

Specifically, the seed of the invention may be a soybean comprising a film coating of L-arginine phosphate source, wherein the amount of nitrogen is about 1.6% of its native nitrogen content.

Alternatively, the seed of the invention may be a maize seed comprising a film coating of L-arginine phosphate source, wherein the amount of nitrogen is about 0.8% of its native nitrogen content.

However, the seed of the invention may be any seed that benefits in performance from a thin coating of L-arginine phosphate source; L-lysine phosphate source; or L-arginine phosphate source and L-lysine phosphate source, such as a pea comprising a film coating of L-arginine phosphate, wherein the amount of nitrogen is about 0.2% of its native nitrogen content.

A third aspect of the invention is a composition for use in step (b) of the method of the invention, which is a solid or liquid seed coating composition comprising L-arginine phosphate, L-lysine phosphate, or L-arginine phosphate and L-lysine phosphate in combination with a binder, including but not limited to carboxymethyl cellulose (CMC); polyvinyl alcohol (PVOH or PVA); and gum arabicum. Specifically, the seed coating composition may be a liquid composition comprising L-arginine phosphate and carboxymethyl cellulose (CMC).

A fourth aspect of the invention is a method of preparing a seed treatment composition, which method comprises the steps of
a) determining the nitrogen content of a specified amount of seeds; and
b) providing a mixture comprising
   (i) L-arginine phosphate; L-lysine phosphate; or L-arginine phosphate and L-lysine phosphate in a predetermined concentration; and
   (ii) binder;
wherein said predetermined concentration of L-arginine phosphate source; L-lysine phosphate source; or L-arginine phosphate source and L-lysine phosphate source provides nitrogen in an amount less than the nitrogen content determined in step a). More specifically, said predetermined concentration of L-arginine phosphate source; L-lysine phosphate source; or L-arginine phosphate source and L-lysine phosphate source may provide nitrogen in an amount less than about 2.0% of the nitrogen content determined in step a).

The mixture provided in step b) may be liquid or solid.

The binder may be any binder commonly used in seed treatment, which is inert towards the basic L-amino acid used and towards plant performance such as improving plant height or plant yield. Well known examples of binders commonly used in seed treatment are e.g. carboxymethyl cellulose (CMC); polyvinyl alcohol (PVOH or PVA); and gum arabicum.

The binder may be combined with L-arginine phosphate, L-lysine phosphate, or L-arginine phosphate and L-lysine phosphate in any way convenient for the apparatus envisaged to be used for coating of seeds, such as a slurry or liquid composition.

The seeds to be treated may belong e.g. to the Leguminosae or Poaceae family, such as any of the above-discussed seeds.

Thus, the seeds may belong to the Leguminosae family, such as seeds selected from the group consisting of soybeans, beans, peas, peanuts, and alfalfa.

The predetermined concentration of L-arginine phosphate source; L-lysine phosphate source; or L-arginine phosphate source and L-lysine phosphate source may provide an amount of nitrogen in the range of from about 1.4% to about 1.8%, such as about 1.6%, of the nitrogen content determined in step a).

Alternatively, the seeds may belong to the Poaceae family, such as seeds selected from the group consisting of maize, wheat, rice, oats and barley.

The predetermined concentration of L-arginine phosphate source; L-lysine phosphate source; or L-arginine phosphate source and L-lysine phosphate source may provide an amount of nitrogen in the range of from about 0.01% to about 0.4%, such as about 0.2% of the nitrogen content determined in step a).

Seeds that may be treated in accordance with any one of the aspects of the invention as well as other treatments including adding the above-discussed microbes to said seed, either before, after, or as part of the treatment according to the invention.

All details, features and examples described above in relation to the first, second and third aspect of the invention may apply to this fourth aspect of the invention as well.

### DETAILED DESCRIPTION OF DRAWINGS

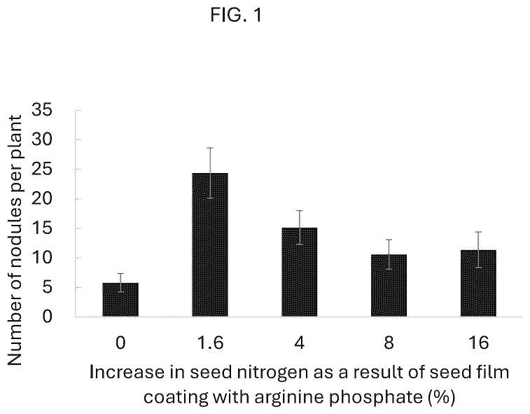

FIG. 1 illustrates the number of soybean root nodules formed per plant (Y axis) as a function of increase of seed nitrogen from film coating of seeds with L-arginine phosphate in accordance with the invention in amounts of 0%, 1.6%, and 4% (X axis). Bars represent average numbers±standard error.

The data presented in FIG. 1 was obtained in a greenhouse experiment with soy seeds film coated with L-arginine phosphate, as described in Example 1 below. It appears clearly from FIG. 1 that an optimum is obtained with a film coating providing 1.6% of nitrogen via the L-arginine, while the number of nodules decreases with a greater amount.

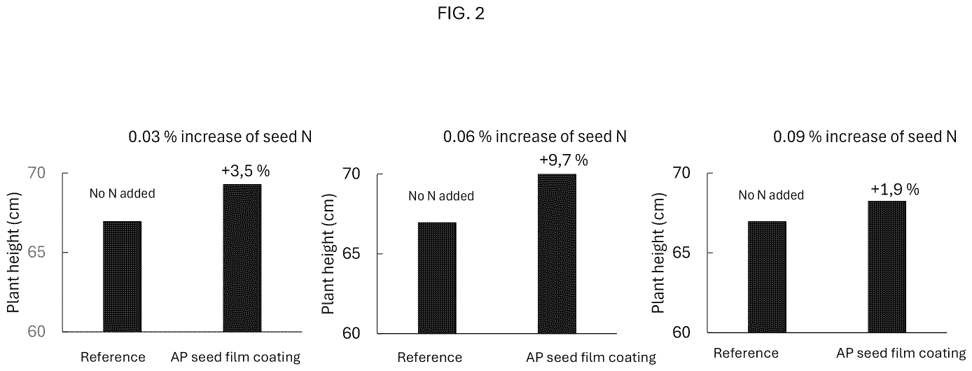

FIG. 2 illustrates the height of soybean plants in cm (Y axis) at 82 days after sowing as a result of film coating of seeds with L-arginine phosphate (AP) according to the invention, corresponding to 0.03, 0.06 and 0.09% increase in seed N content. For each concentration, the plant height is presented to the left for a reference plant without treatment according to the invention; and the plant height is presented to the right for a plant treated according to the invention.

The data presented in FIG. 2 was obtained in a field experiment with soy seeds film coated with L-arginine phosphate, as described in Example 2 below.

It appears clearly from FIG. 2 that the chosen low amounts of nitrogen added through the invention surprisingly leads to increased growth rates, illustrated by an increased height (cm) of plants treated with the invention.

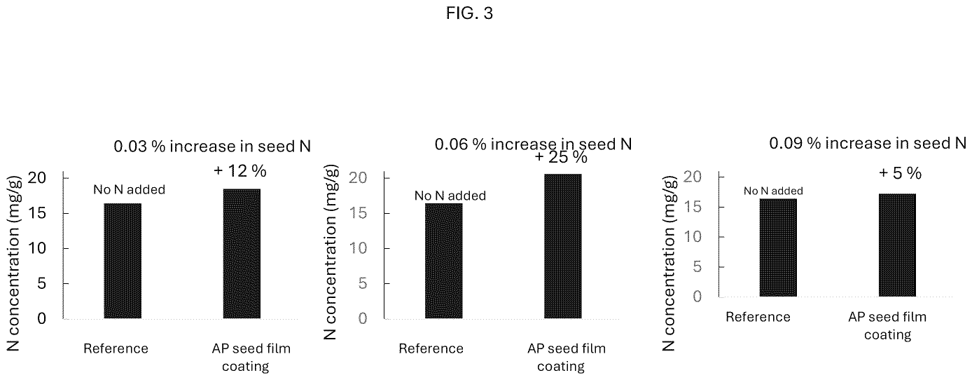

FIG. 3 illustrates the leaf concentrations of nitrogen (N) 73 days after sowing as affected by seed coating with L-arginine phosphate corresponding to 0.03; 0.06 and 0.09% increase in seed N content.

The data presented in FIG. 3 was obtained in a field experiment with soy seeds film coated with L-arginine phosphate, as described in Example 3 below.

It appears clearly from FIG. 3 that the chosen low amounts of nitrogen added through the invention surprisingly leads to increased nutrient accumulation in the plants, illustrated by an increased nitrogen uptake (mg/g) of plants treated with the invention.

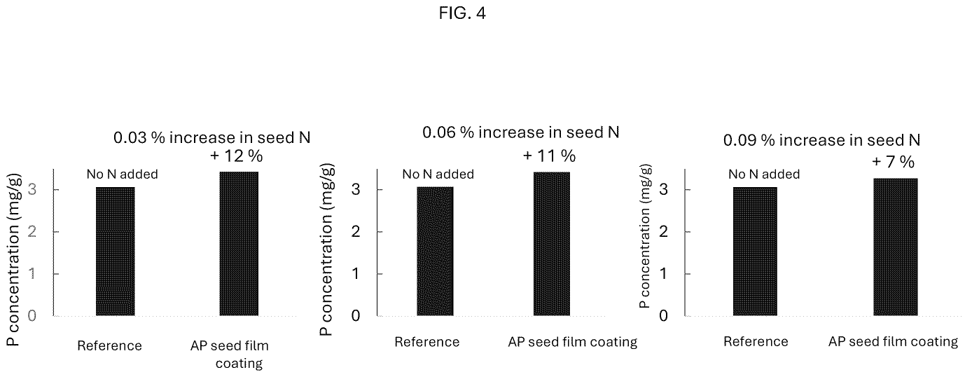

FIG. 4 illustrates the leaf concentrations of nitrogen (N) and phosphorus (P) 73 DAS as affected by seed coating with L-arginine phosphate corresponding to 0.03; 0.06 and 0.09% increase in seed N content.

The data presented in FIG. 4 was obtained in a field experiment with soy seeds film coated with L-arginine phosphate, as described in Example 4 below.

It appears clearly from FIG. 4 that the chosen low amounts of nitrogen added through the invention surprisingly lead to increased nutrient accumulation in the plants, illustrated by an increased phosphorus uptake (mg/g) of plants treated with the invention.

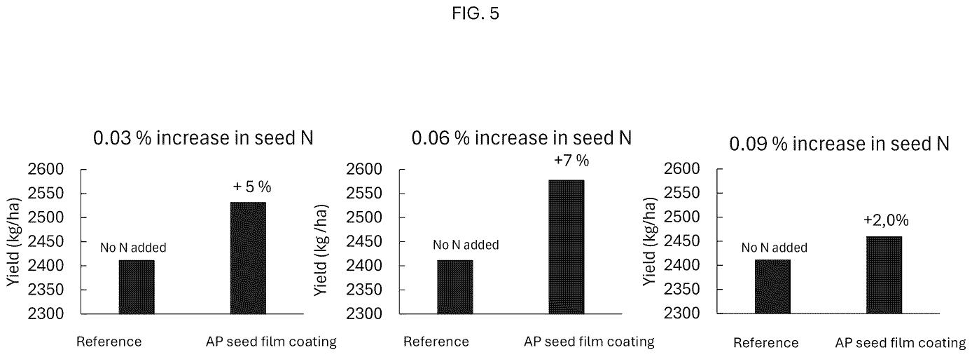

FIG. 5 illustrates the yield of soybean as affected by seed coating with L-arginine phosphate corresponding to 0.03; 0.06 and 0.09% increase in seed N content.

The data presented in FIG. 5 was obtained in a field experiment with soy seeds film coated with L-arginine phosphate, as described in Example 5 below.

It appears clearly from FIG. 5 that the chosen low amounts of nitrogen added through the invention surprisingly lead to increased yield (kg/ha).

FIG. 6 illustrates the yield of soybeans from plots treated according to farmer standard (Reference) or with a 40% reduction of phosphorus addition compared the standard, or with 40% reduction of phosphorus fertilization+seed coating with L-arginine phosphate corresponding to 0.03; 0.06 and 0.09% increase in seed N content. Percentage numbers on top of the bar for 40% reduction of P fertilizer+seed coating represents the fraction of yield loss that was compensated by the L-arginine phosphate seed coating.

The data presented in FIG. 6 was obtained in a field experiment with soy seeds film coated with L-arginine phosphate, as described in Example 6 below.

It appears clearly from FIG. 6 that a reduced application rate of phosphorus fertilizer has a strong negative effect on soybean yield. It is also clear from FIG. 6 that film coating of soybeans with arginine phosphate alleviates this negative effect of the reduced phosphorus fertilization on soybean yield and even promotes a higher yield that the reference with full phosphorus fertilization.

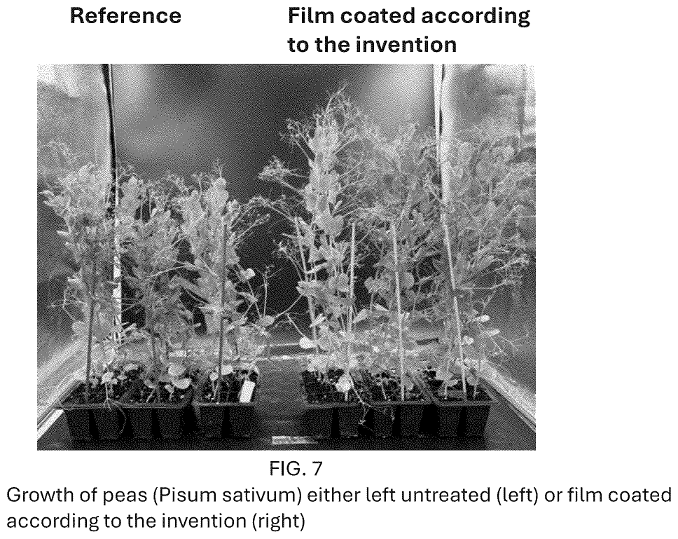

FIG. 7 illustrates growth performance of pea (Pisum sativum) plants originating from seeds either left untreated or treated according to the invention. Plants were grown in pots in non-fertilized soil in a greenhouse for 6 weeks.

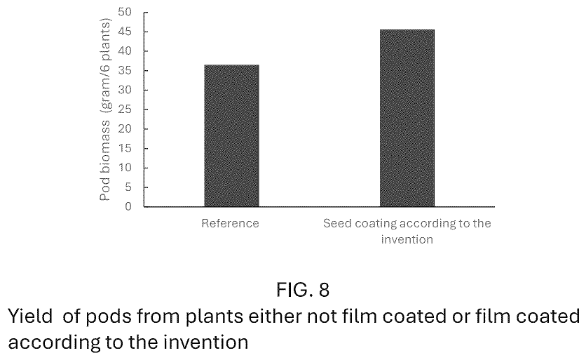

FIG. 8 illustrates yield of pods from pea (Pisum sativum) plants originating from seeds either left untreated or treated according to the invention. Plants were grown in sowing soil in pots in non-fertilized soil in a greenhouse for 5 weeks and pods were harvested after 8 weeks from 6 plants and weighed.

### EXPERIMENTAL

The present examples are provided for illustrative purposes only and should not be construed as limiting the invention as defined by the appended claims.

All references below and elsewhere in the present application are hereby included herein via reference.

### Materials and Methods

The L-arginine phosphate referred to below was L-arginine monophosphate prepared according to WO2017200468 (Arevo AB).

### EXAMPLES

### Example 1

Soybean seeds were coated with a standard seed coating machine used in the industry. For this, first a slurry composed of L-arginine phosphate in combination with a binder was prepared, sprayed on soybean seeds that were in motion in the seed coating machine. Drying of the film coating was achieved at room temperature while seeds were in motion in the seed coating machine. According to the invention, different levels of L-arginine phosphate were used, spanning 0-1,6% of seed nitrogen. This range was established from the ratio of the amount of nitrogen added as arginine phosphate in the seed coating per seed to the amount of nitrogen per seed contained in the naked seed.

Seeds were planted in inoculated planting soil in standard pots and grown under standard greenhouse conditions for 4 weeks. Seedlings were carefully taken out of pots and the root system was washed to remove soil. The presence of root nodules was investigated and nodules per root system were counted.

The results are presented in FIG. 1.

### Example 2

Soybean seeds were coated with a standard seed coating machine used in the industry. For this first, a slurry composed of L-arginine phosphate in combination with a binder was prepared, sprayed on soybean seeds that were in motion in the seed coating machine. Drying of the film coating was achieved at room temperature while seeds were in motion in the seed coating machine. According to the invention, different levels of L-arginine phosphate were used, corresponding from 0.03-0.09% in increase of seed nitrogen.

Seeds were used for a randomised complete block design field study in France, where plot sizes were 30 m². Four replicates were executed. As reference, standard soybean fertilization of 117.4 kg Triple Super Phosphate (TSP)/ha—as typical for this location—was used. After 82 days, plant height in cm was measured of a representative amount of plants per plot, for all four replicates per treatment.

The results are presented in FIG. 2.

### Example 3

Soybean seeds were coated with a standard seed coating machine used in the industry. For this first, a slurry composed of L-arginine phosphate in combination with a binder was prepared, sprayed on soybean seeds that were in motion in the seed coating machine. Drying of the film coating was achieved at room temperature while seeds were in motion in the seed coating machine. According to the invention, different levels of L-arginine phosphate were used, corresponding from 0.03-0.09% in increase of seed nitrogen.

Seeds were used for a randomised complete block design field study in France, where plot sizes were 30 m². Four replicates were executed. As reference, standard soybean fertilization of 117.4 kg Triple Super Phosphate (TSP)/ha—as typical for this location—was used. The nutrient analysis of leaf nitrogen concentration was performed by Eurofins Galys Ancenis, 73 days after sowing, based on at least 200 leaves per plot for analysis, for all four replicates.

The results are presented in FIG. 3.

### Example 4

Soybean seeds were coated with a standard seed coating machine used in the industry. For this first, a slurry composed of L-arginine phosphate in combination with a binder was prepared, sprayed on soybean seeds that were in motion in the seed coating machine. Drying of the film coating was achieved at room temperature while seeds were in motion in the seed coating machine. According to the invention, different levels of L-arginine phosphate were used, corresponding from 0.03-0.09% in increase of seed nitrogen.

Seeds were used for a randomised complete block design field study in France, where plot sizes were 30 m². Four replicates were executed. As reference, standard soybean fertilization of 117.4 kg Triple Super Phosphate (TSP)/ha—as typical for this location—was used. The nutrient analysis of leaf phosphorus concentration was performed by Eurofins Galys Ancenis, 73 days after sowing, based on at least 200 leaves per plot for analysis, for all four replicates.

The results are presented in FIG. 4.

### Example 5

Soybean seeds were coated with a standard seed coating machine used in the industry. For this first, a slurry composed of L-arginine phosphate in combination with a binder was prepared, sprayed on soybean seeds that were in motion in the seed coating machine. Drying of the film coating was achieved at room temperature while seeds were in motion in the seed coating machine. According to the invention, different levels of L-arginine phosphate were used, corresponding from 0.03-0.09% in increase of seed nitrogen.

Seeds were used for a randomised complete block design field study in France, where plot sizes were 30 m². Four replicates were executed. As reference, standard soybean fertilization of 117.4 kg Triple Super Phosphate (TSP)/ha—as typical for this location—was used. Yield was assessed after the end of the cultivation season and compared to the reference yield.

The results are presented in FIG. 5.

### Example 6

Soybean seeds were coated with a standard seed coating machine used in the industry. For this first, a slurry composed of L-arginine phosphate in combination with a binder was prepared, sprayed on soybean seeds that were in motion in the seed coating machine. Drying of the film coating was achieved at room temperature while seeds were in motion in the seed coating machine. According to the invention, different levels of L-arginine phosphate were used, corresponding from 0.03-0.09% in increase of seed nitrogen.

Seeds were used for a randomised complete block design field study in France, where plot sizes were 30 m². Four replicates were executed. As reference, standard soybean fertilization of 117.4 kg Triple Super Phosphate (TSP)/ha—as typical for this location—was used. In addition a reduction by 40% of standard TSP addition was used for plant cultivation to illustrate loss of crop yield as a dependency on available plant nutrition in the soil. In the same condition of 40% reduction in fertilization, seeds were cultivated that were treated according to the invention. The reduction in soybean yield caused by the reduction of addition of TSP per hectare was alleviated by the invention. Thus, the loss in yield was compensated, or even over-compensated by the invention.

The results are presented in FIG. 6.

### Example 7

Soybean seeds were coated with a standard seed coating machine used in the industry. For this first, a slurry composed of L-arginine phosphate in combination with a CMC was prepared, sprayed on soybean seeds that were in motion in the seed coating machine. Drying of the film coating was achieved at room temperature while seeds were in motion in the seed coating machine. According to the invention, L-arginine phosphate was used, corresponding to a 0.07% increase of seed nitrogen. Seeds were used for a randomised complete block design field study in four locations, where plot sizes were 30 m²: Trials included farmer standard application rates of either superphosphate or NPK (4-14-18) as well as rates reduced from farmers standard with 20, 40 and 60%. Four replicates were executed. The mature crop was harvested and yield assessed for each plot. The potential for increase in yield resulting from the seed film coating according to the invention is presented in Table 1 below:

TABLE 1

| Trial location | Yield increase |
|---|---|
| 1. Medium textured soil, acidic pH | 3.5% |
| 2. Medium textured soil of neutral pH | 7.1% |
| 3. Fine textured soil of acidic pH | 13.0% |
| 4. Fine textured soil of acidic pH | 5.2% |

The potential for reduction of fertilizer input using the invention was calculated based on a polynomial regression with the rate of fertilizer input as independent variable and yield as dependent variable for seeds without and with coating according to the invention.

The results from this analysis are presented in Table 2 below:

TABLE 2

| | Reduction | Reduction | Full rate of | |
|---|---|---|---|---|
| Trial | potential | potential | fertilizer | |
| location | (%) | (kg/ha) | (kg/ha) | Fertilizer type |
| 1. Medium | 16% | 48 | 300 | Superphosphate |
| textured soil, | | | | |
| acidic pH | | | | |
| 2. Medium | 22% | 66 | 300 | Superphosphate |
| textured soil of | | | | |
| neutral pH | | | | |
| 3. Fine textured | 32% | 96 | 300 | NPK (4-14-18) |
| soil of acidic pH | | | | |
| 4. Fine textured | 33% | 99 | 300 | NPK (4-14-18) |
| soil of acidic pH | | | | |

### Example 8

Seeds of field corn were coated with a standard seed coating machine used in the industry. For this first, a slurry composed of L-arginine phosphate in combination with a binder was prepared, sprayed on soybean seeds that were in motion in the seed coating machine. Drying of the film coating was achieved at room temperature while seeds were in motion in the seed coating machine. According to the invention, L-arginine phosphate was used, corresponding to a 0.8% increase of seed nitrogen. Seeds were used for a randomised complete block design field study in three locations, where plot sizes were 30 m². Trials included farmer standard application rates of either Urea or Ammonium nitrate or Urea in combination with MAP or a combination of Urea, NPK (11-52-0) and ammonium sulfate at rates depicted in Table 4 as well as rates reduced from farmers standard with 10, 20, 30 and 40%. Four replicates were executed. The mature crop was harvested and yield assessed for each plot. The potential for increase in yield resulting from the seed film coating according to the invention is presented in Table 3 below:

TABLE 3

| Trial location | Yield increase |
|---|---|
| 1. Medium textured soil of acidic pH | 6.5% |
| 2. Medium textured soil of neutral pH | 1.4% |
| 3. Fine textured soil of acidic pH | 5.6% |

The potential for reduction of fertilizer input using the invention was calculated based on a polynomial regression with the rate of fertilizer input as independent variable and yield as dependent variable for seeds without and with coating according to the invention.

The results from this analysis are presented in Table 4 below:

TABLE 4

| | Reduction | Reduction | Full rate of | |
|---|---|---|---|---|
| | potential | potential (kg | fertilizer (kg | |
| Trial location | (%) | nitrogen/ha) | nitrogen/ha) | Fertilizer type |
| 1. Medium | 21% | 32 | 152 | Ammonium |
| textured soil of | | | | nitrate |
| acidic pH | | | | |
| 2. Medium | 45% | 85 | 189 | Urea + Mono |
| textured soil of | | | | ammonium |
| neutral pH | | | | phosphate |
| 3. Fine textured | 36% | 53 | 147 | NPK (4-14-18), |
| soil of acidic pH | | | | Urea & |
| | | | | Ammonium |
| | | | | sulfate |

### Example 9

Seeds of peas (Pisum sativum) were coated with a standard seed coating machine used in the industry. For this first, a slurry composed of L-arginine phosphate in combination with a binder was prepared, sprayed on pea seeds that were in motion in the seed coating machine. Drying of the film coating was achieved at room temperature while seeds were in motion in the seed coating machine. According to the invention, L-arginine phosphate was used, corresponding to a 0.2% increase of seed nitrogen. The results are presented in FIGS. 7 and 8.

1. A method of seed treatment, which method comprises the steps of
a) providing seeds;
b) providing a seed coating composition by combining L-arginine phosphate source, L-lysine phosphate source, or L-arginine phosphate source and L-lysine phosphate source with binder; and
c) coating the seeds of step (a) with the coating composition of step (b) such that a film having a thickness of about 125 μm or less is provided on each seed.

2. The method of claim 1, wherein the L-arginine phosphate source; L-lysine phosphate source; or L-arginine phosphate source and L-lysine phosphate source and binder is sprayed onto said seeds.

3. A method of claim 1, wherein step (c) of the process includes tumbling of the seeds with the coating composition of step (a).

4. The method acoroding of claim 1, wherein the binder is selected to be inert towards the L-arginine phosphate source; L-lysine phosphate source; or L-arginine phosphate source and L-lysine phosphate source and towards plant performance.

5. The method of claim 4, wherein the binder is selected from the group consisting of carboxymethyl cellulose (CMC); polyvinyl alcohol (PVA or PVOH) and gum arabicum.

6. The method of claim 1, wherein the seeds are naked seeds; or seeds which have been pre-treated with pesticide.

7. The method of claim 1, wherein in step (a), seeds belonging to the Leguminosae family are provided.

8. The method of claim 7, wherein said seeds are selected from the group consisting of soybeans, beans, peas, peanuts and alfalfa.

9. A method according of claim 1, wherein in step (a), seeds belonging to the Poaceae family are provided.

10. The method of claim 9, wherein said seeds are cereal crop seeds or forage crop seeds.

11. The method of claim 10, wherein said seeds are cereal crops selected from the group consisting of maize, wheat, rice, oats and barley.

12. The method of claim 1, wherein said seeds belong to N-fixing breeds or breeds that form associations with free-living N-fixing microbes.

13. The method of claim 12, which comprises a step of adding N-fixing microbes to the seed.

14. The method of claim 13, wherein said microbes include those belonging to the genera selected from the group consisting of Rhizobium, Azospirillum, Azotobacter, Herbaspirillum, Enterobacter, Bradyrhizobium, Mesorhizobium and Frankia.

15. The method of claim 1, wherein the L-arginine phosphate source; L-lysine phosphate source; or L-arginine phosphate source and L-lysine phosphate source are added in an amount that provides a smaller amount of nitrogen to each seed than the native nitrogen content of said seed.

16. A seed treated by the method of claim 15, wherein the amount of nitrogen provided by the L-arginine phosphate source; L-lysine phosphate source; or L-arginine phosphate source and L-lysine phosphate source in the coating is in the range of from about 0.01% to about 2.0% of its native nitrogen content, calculated as weight/weight based on the native nitrogen content of the seeds.

17. The seed of claim 16, which is a seed belonging to the Leguminosae family comprising a film coating of L-arginine phosphate source, wherein the amount of nitrogen is in the range of from about 1.4% to about 1.8%, calculated as weight/weight based on the native nitrogen content of the seeds.

18. The seed of claim 16, which is a seed belonging to the Poaceae family comprising a film coating of L-arginine phosphate source, wherein the amount of nitrogen is in the range of from about 0.6% to about 1.0%, calculated as weight/weight based on the native nitrogen content of the seeds.

19. A seed coating composition for use in step (b) of the method 16, which is a solid or liquid composition comprising L-arginine phosphate source; L-lysine phosphate source; or L-arginine phosphate source and L-lysine phosphate source in combination with a binder.

20. The seed coating composition of claim 19, which is a liquid composition comprising L-arginine phosphate and carboxymethyl cellulose (CMC).

21. A method of preparing a seed coating composition, which method comprises the steps of
a) determining the nitrogen content of a specified amount of native seeds; and
b) providing a mixture comprising
(i) L-arginine phosphate source; L-lysine phosphate source; or L-arginine phosphate source and L-lysine phosphate source in a predetermined concentration; and
(ii) binder;
wherein said predetermined concentration of L-arginine phosphate source; L-lysine phosphate source; or L-arginine phosphate source and L-lysine phosphate source provides nitrogen in an amount less than the nitrogen content determined in step a).

22. The method of claim 21 wherein said predetermined concentration of L-arginine phosphate source; L-lysine phosphate source; or L-arginine phosphate source and L-lysine phosphate source provides nitrogen in an amount less than about 2.0% of the nitrogen content determined in step a).

23. The method of claim 21, wherein the seeds belong to the Leguminosae family.

24. The method of claim 23 wherein said-said predetermined concentration of L-arginine phosphate source; L-lysine phosphate source; or L-arginine phosphate source and L-lysine phosphate source provides an amount of nitrogen in the range of from about 1.4% to about 1.8%, such as about 1.6%, of the nitrogen content determined in step a).

25. The method of claim 23, wherein the seeds are selected from the group consisting of soybeans, beans, peas, peanuts, and alfalfa.

26. The method of claim 21, wherein the seeds belong to the Poaceae family.

27. The method of claim 26, wherein said predetermined concentration of L-arginine phosphate source; L-lysine phosphate source; or L-arginine phosphate source and L-lysine phosphate source provides an amount of nitrogen in the range of from about 0.01% to about 0.4% of the nitrogen content determined in step a).

28. The method of claim 26, wherein the seeds are selected from the group consisting of maize, wheat, rice, oats and barley.

29. The seed coating composition of claim 19, wherein the binder is selected from the group consisting of carboxymethyl cellulose (CMC); polyvinyl alcohol (PVA or PVOH) and gum arabicum.
